(19) United States
(12) Patent Application Publication
(10) Pub. No.: US 2020/0412289 A1
(43) Pub. Date: Dec. 31, 2020

(54) METHOD AND APPARATUS FOR MOTOR EXCITATION SIGNAL GENERATION AND COMPUTER DEVICE

(71) Applicant: AAC Technologies Pte. Ltd., Singapore city (SG)

(72) Inventor: Yingming Qin, Shenzhen (CN)

(21) Appl. No.: 16/945,917

(22) Filed: Aug. 2, 2020

Related U.S. Application Data
(63) Continuation of application No. PCT/CN2019/094078, filed on Jun. 30, 2019.

(51) Int. Cl. H02P 25/032; A63F 13/285

(52) U.S. Cl. CPC H02P 25/032; A63F 13/285

(57) ABSTRACT

The embodiments of the present invention provide a method and an apparatus for motor excitation signal generation, and a computer device. The method includes: obtaining an impulse response function and an impedance curve of a target motor; obtaining a Noise to Signal Ratio (NSR) parameter and a target vibration signal corresponding to the target motor; and generating a target motor excitation signal corresponding to the target vibration signal based on the impulse response function, the impedance curve, the NSR parameter, and the target vibration signal. In this way, the efficiency and accuracy of the motor excitation signal generation can be improved.

### TECHNICAL FIELD

The present invention relates to the field of motor technology, and more particularly, to a method and an apparatus for motor excitation signal generation, and a computer device.

### BACKGROUND

Most currently available games, such as action, adventure, simulation, role-playing, leisure, and other categories of games, generally focus on visual and audible interactions, without intuitive tactile experience. If stimulation of tactile sensations can be added to the games, immersive experiences for players can be enhanced. Specifically, the generation of tactile sensations depends on tactile signals, which are mainly vibration signals generated by motors. Different excitation signals can be provided for a target motor, so as to obtain rich tactile effects.

At present, an excitation signal is mainly determined by using the original excitation signal to generate a corresponding vibration signal, and then continuously adjusting the excitation signal to make the generated vibration signal match a desired vibration signal. Such adjustment is inaccurate, and it is difficult to obtain the vibration signal matching the desired vibration signal, so it is also difficult to obtain an accurate excitation signal corresponding to the desired vibration signal. Additionally, if there is an adjustment direction error during the adjustment process, it will inevitably cost a lot of time for the adjustor to keep adjusting in order to get close to a correct result, which is inefficient.

### SUMMARY

In view of the above problem, it is an object of the present invention to provide a method and an apparatus for motor excitation signal generation, and a computer device, capable of determining an excitation signal efficiently and accurately.

In an embodiment, a method for motor excitation signal generation is provided. The method includes: obtaining an impulse response function and an impedance curve of a target motor; obtaining a Noise to Signal Ratio (NSR) parameter and a target vibration signal corresponding to the target motor; and generating a target motor excitation signal corresponding to the target vibration signal based on the impulse response function, the impedance curve, the NSR parameter, and the target vibration signal.

In an embodiment, the step of obtaining the impulse response function and the impedance curve of the target motor may include: driving the target motor with a predetermined excitation signal to obtain voltage data, current data and vibration acceleration data, and the predetermined excitation signal having a plurality of frequency points; obtaining the impedance curve based on the voltage data, the current data, and each frequency point in the predetermined excitation signal; obtaining a motor frequency response function based on the vibration acceleration data and each frequency point in the predetermined excitation signal; and obtaining the impulse response function of the target motor based on the motor frequency response function by means of inverse Fourier transform.

In an embodiment, the step of generating the target motor excitation signal corresponding to the target vibration signal based on the impulse response function, the impedance curve, the NSR parameter, and the target vibration signal may include: obtaining a first motor excitation signal corresponding to the target vibration signal based on the impulse response function, the impedance curve, the NSR parameter and the target vibration signal; obtaining a second motor excitation signal corresponding to the target vibration signal; and obtaining the target motor excitation signal corresponding to the target vibration signal based on the first motor excitation signal and the second motor excitation signal.

In an embodiment, the step of obtaining the second motor excitation signal corresponding to the target vibration signal may include: obtaining a resonance frequency of the target motor; and obtaining the second motor excitation signal corresponding to the target vibration signal based on the resonance frequency.

In an embodiment, the step of obtaining the target motor excitation signal corresponding to the target vibration signal based on the first motor excitation signal and the second motor excitation signal may include: obtaining a brake position determined by exciting the target motor with the first motor excitation signal; and combining the first motor excitation signal and the second motor excitation signal based on the brake position to obtain the target motor excitation signal corresponding to the target vibration signal.

In an embodiment, the method may further include, subsequent to generating the target motor excitation signal corresponding to the target vibration signal based on the impulse response function, the impedance curve, the NSR parameter, and the target vibration signal: storing the motor excitation signal corresponding to the target vibration signal in a tactile sensation library.

In an embodiment, an apparatus for motor excitation signal generation is provided. The apparatus includes: a first obtaining module configured to obtain an impulse response function and an impedance curve of a target motor; a second obtaining module configured to obtain a Noise to Signal Ratio (NSR) parameter and a target vibration signal corresponding to the target motor; and a signal generating module configured to generate a target motor excitation signal corresponding to the target vibration signal based on the impulse response function, the impedance curve, the NSR parameter, and the target vibration signal.

In an embodiment, the first obtaining module may include: a driving module configured to drive the target motor with a predetermined excitation signal to obtain voltage data, current data and vibration acceleration data, and the predetermined excitation signal having a plurality of frequency points; an impedance obtaining module configured to obtain the curve based on the voltage data, the current data, and each frequency point in the predetermined excitation signal; a frequency response function determining module configured to obtain a motor frequency response function based on the vibration acceleration data and each frequency point in the predetermined excitation signal; and an impulse response function determining module configured to obtain the impulse response function of the target motor based on the motor frequency response function by means of inverse Fourier transform.

In an embodiment, the signal generating module may include: a first exciting module configured to obtain a first motor excitation signal corresponding to the target vibration signal based on the impulse response function, the impedance curve, the NSR parameter and the target vibration signal; a second exciting module configured to obtain a second motor excitation signal corresponding to the target vibration signal; and a target exciting module configured to obtain the target motor excitation signal corresponding to the target vibration signal based on the first motor excitation signal and the second motor excitation signal.

In an embodiment, the second exciting module may include: a resonance frequency obtaining module configured to obtain a resonance frequency of the target motor; and an excitation signal determining module configured to obtain the second motor excitation signal corresponding to the target vibration signal based on the resonance frequency.

In an embodiment, the target exciting module may include: a brake position obtaining module configured to obtain a brake position determined by exciting the target motor with the first motor excitation signal; and a brake combining module configured to combine the first motor excitation signal and the second motor excitation signal based on the brake position to obtain the target motor excitation signal corresponding to the target vibration signal.

In an embodiment, the apparatus may further include: a storage module configured to storing the motor excitation signal corresponding to the target vibration signal in a tactile sensation library.

In an embodiment, a computer device is provided. The computer device includes a memory and a processor. The memory stores a computer program which, when executable by the processor, causes the processor to: obtain an impulse response function and an impedance curve of a target motor; obtain a Noise to Signal Ratio (NSR) parameter and a target vibration signal corresponding to the target motor; and generate a target motor excitation signal corresponding to the target vibration signal based on the impulse response function, the impedance curve, the NSR parameter, and the target vibration signal.

In an embodiment, a computer readable storage medium is provided. The computer readable storage medium stores a computer program which, when executed by a processor, causes the processor to: obtain an impulse response function and an impedance curve of a target motor; obtain a Noise to Signal Ratio (NSR) parameter and a target vibration signal corresponding to the target motor; and generate a target motor excitation signal corresponding to the target vibration signal based on the impulse response function, the impedance curve, the NSR parameter, and the target vibration signal.

The embodiments of the present invention have the following advantageous effects. The present invention provides a method and an apparatus for motor excitation signal generation, and a computer device. First, an impulse response function and an impedance curve of a target motor are obtained. Then, an NSR parameter and a target vibration signal corresponding to the target motor are obtained. Finally, a target motor excitation signal corresponding to the target vibration signal is generated based on the impulse response function, the impedance curve, the NSR parameter, and the target vibration signal. In this way, since the impulse response function and the impedance curve, which reflect the characteristics of the motor, and the target vibration signal to be simulated are obtained, the motor excitation signal is reversely derived based on the impulse response function and the target vibration signal. Compared with the method for existing excitation signal determination, it does not need to repeatedly adjust the excitation signal, which greatly improves the efficiency in determining the excitation signal. Further, it would be difficult to obtain the desired target vibration signal by repeatedly adjusting the excitation signal to obtain the target vibration signal, and the determined excitation signal is inaccurate. According to the present invention, the excitation signal is reversely derived from the target vibration signal directly, and the excitation signal so obtained is more accurate.

### BRIEF DESCRIPTION OF DRAWINGS

In order to explain the embodiments of the present invention or the technical solutions in the prior art more clearly, the drawings used in the description of the embodiments or the prior art will be briefly introduced in the following. Obviously, the drawings in the following description are only some of the embodiments of the present invention. For those of ordinary skill in the art, other drawings can be obtained based on these drawings without any inventive efforts.

FIG. 1 is a schematic diagram showing an implementation process of a method for motor excitation signal generation according to an embodiment;

FIG. 2 is a schematic diagram showing an implementation process of a method for motor excitation signal generation according to an embodiment;

FIG. 3 is a schematic diagram showing a chirp signal according to an embodiment;

FIG. 4 is a schematic diagram showing an implementation process of a method for motor excitation signal generation according to an embodiment;

FIG. 5 is a block diagram showing a structure of an apparatus for motor excitation signal generation according to an embodiment; and

FIG. 6 is a block diagram showing a structure of a computer device according to an embodiment.

### DESCRIPTION OF EMBODIMENTS

In the following, the solutions according to the embodiments of the present invention will be described clearly and completely with reference to the accompanying drawings for the embodiments of the present invention. Obviously, the described embodiments are only a part of the embodiments of the present invention, but not all the embodiments. All other embodiments obtained by those having ordinary skill in the art based on the embodiments of the present invention, without inventive efforts, fall within the scope of the present invention.

For a motor vibration system, a motor will vibrate when excited with an excitation signal to generate vibration data, and a vibration signal can be obtained based on the vibration data.

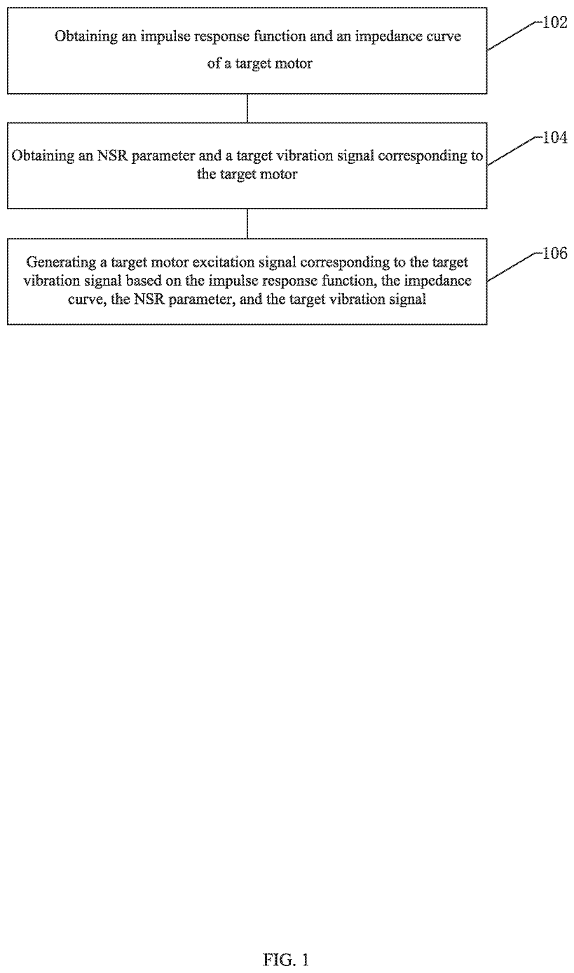

As shown in FIG. 1, in an embodiment, a method for motor excitation signal generation is provided. The method for motor excitation signal generation according to an embodiment of the present invention is performed by an apparatus capable of implementing the method for motor excitation signal generation according to the embodiment of the present invention. The apparatus may include, but not limited to, a server or a terminal. Here, the terminal may include a desktop computer, and the server may include a high-performance computer and a high-performance computer cluster. The method for motor excitation signal generation includes the following steps.

At step S102, an impulse response function and an impedance curve of a target motor are obtained.

Here, the impedance curve is a curve reflecting a correspondence between frequency points and impedance. Here, the impedance can be determined based on a voltage and a current.

Different motors have different impulse response functions, and the entity for performing the method for motor excitation signal generation method can store impulse response functions of different motors.

At step S104, a Noise to Signal Ratio (NSR) parameter and a target vibration signal corresponding to the target motor are obtained.

Here, the NSR parameter is a ratio of a power spectrum function of noise to a power spectrum function of an input signal. Let N(ƒ) represent the power spectrum function of noise, S(ƒ) represent the power spectrum function of the input signal, and NSR represent the noise to signal ratio, then NSR=N(ƒ)/S(ƒ).

Here, the vibration signal is generated by the motor vibrating when excited by an excitation signal. In particular, the vibration signal can be a vibration acceleration signal.

At step S106, a target motor excitation signal corresponding to the target vibration signal is generated based on the impulse response function, the impedance curve, the NSR parameter, and the target vibration signal.

Here, the motor excitation signal is a signal for driving the motor to vibrate, and is also referred to as a frequency sweep signal.

The system that excites the motor with the motor excitation signal to make the motor vibrate has a transfer function H(ƒ), and the vibration signal in response to the motor excitation signal can be obtained based on the motor excitation signal and the transfer function, where the transfer function H(ƒ) is determined based on the impulse response function and impedance curve.

Assuming that the system that excites the motor with the motor excitation signal to make the motor vibrate is referred to as a forward system, then a system that determines the motor excitation signal for exciting the motor to vibrate based on the vibration signal outputted by the motor can be referred to as an reverse system as opposite to the forward system. The transfer function H(ƒ) in the forward system is referred to as a forward transfer function. Accordingly, the transfer function in the reverse system is referred to as a reverse transfer function. For the reverse system, the motor excitation signal corresponding to the target vibration signal can be reversely derived from the reverse transfer function and the target vibration signal. In particular, the forward transfer function H(ƒ) can be determined based on the impulse response function and the impedance curve, and the reverse transfer function G(ƒ) can be:

$$G ( f ) = \frac{{H}^{*} ( f )}{{\vert H ( f ) \vert}^{2} + \frac{N ( f )}{S ( f )}} ,$$

where H*(ƒ) is the conjugate function of H(ƒ).

In particular, the motor excitation signal corresponding to the target vibration signal can be reversely derived from the reverse transfer function and the target vibration signal according to:

\hat{X}(ƒ)=G(ƒ)Y(ƒ),
where Y(ƒ) is a Fourier transform representation of the target vibration signal, and \hat{X}(ƒ) is the outputted target motor excitation signal.

With the above-described method for motor excitation signal generation, first, an impulse response function and an impedance curve of a target motor are obtained. Then, an NSR parameter and a target vibration signal corresponding to the target motor are obtained. Finally, a target motor excitation signal corresponding to the target vibration signal is generated based on the impulse response function, the impedance curve, the NSR parameter, and the target vibration signal. In this way, since the impulse response function and the impedance curve, which reflect the characteristics of the motor, and the target vibration signal to be simulated are obtained, the motor excitation signal is reversely derived based on the impulse response function and the target vibration signal. Compared with the method for existing excitation signal determination, it does not need to repeatedly adjust the excitation signal, which greatly improves the efficiency in determining the excitation signal. Further, it would be difficult to obtain the desired target vibration signal by repeatedly adjusting the excitation signal to obtain the target vibration signal, and the determined excitation signal is inaccurate. According to the present invention, the excitation signal is reversely derived from the target vibration signal directly, and the excitation signal so obtained is more accurate.

In an embodiment, the method may further include, subsequent to the step 106 of generating the target motor excitation signal corresponding to the target vibration signal based on the impulse response function, the impedance curve, the NSR parameter, and the target vibration signal: a step 108 of storing the motor excitation signal corresponding to the target vibration signal in a tactile sensation library.

By storing the obtained motor excitation signal in the tactile sensation library, various excitation signals for the target motor can be obtained, thereby obtaining abundant tactile effects for the target motor.

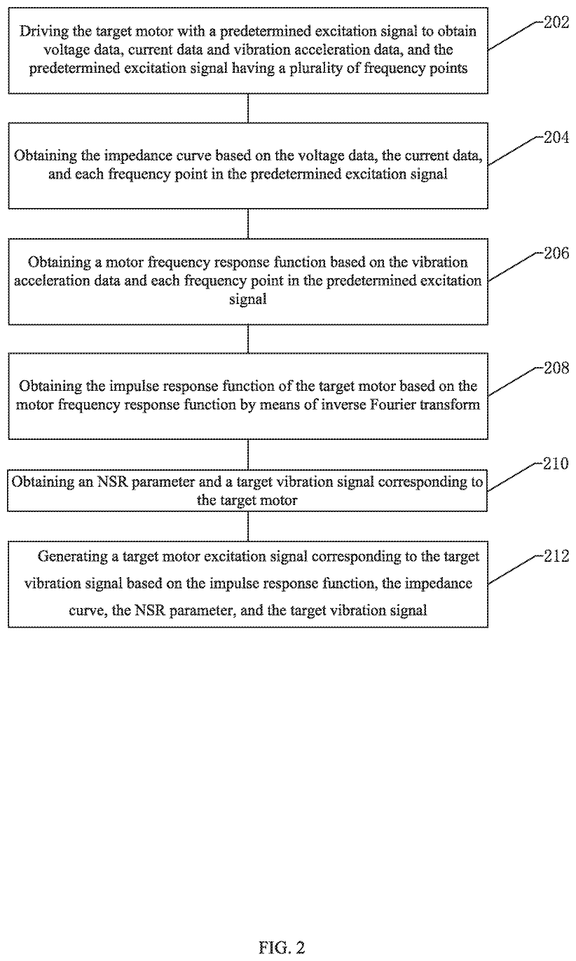

In an embodiment, as shown in FIG. 2, a method for motor excitation signal generation is provided, which illustrates a scheme for obtaining an impulse response function and an impedance curve. Specifically, the method for motor excitation signal generation according to the embodiment of the present invention includes the following steps.

At step 202, the target motor is driven with a predetermined excitation signal to obtain voltage data, current data and vibration acceleration data. The predetermined excitation signal has a plurality of frequency points.

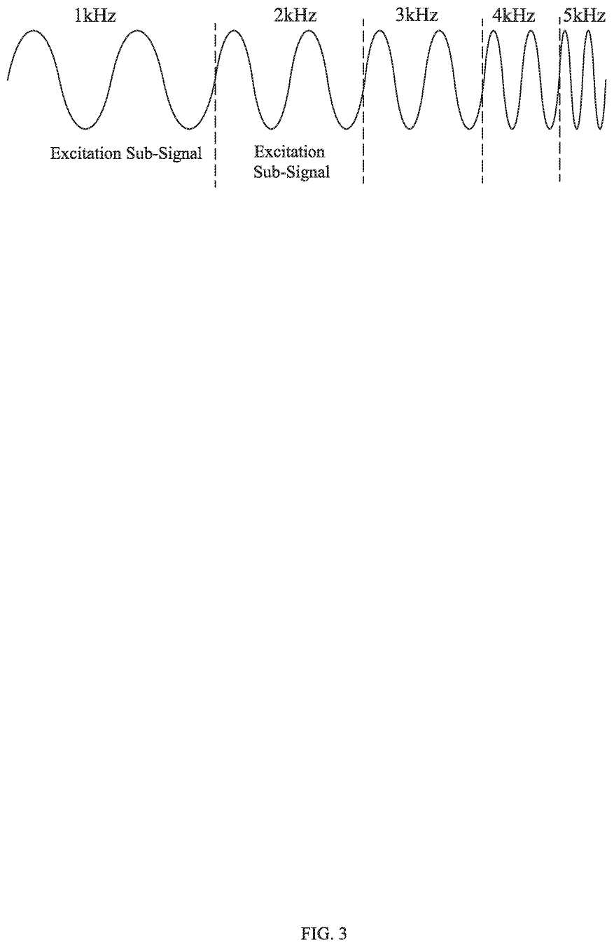

Here, the predetermined excitation signal, as shown in FIG. 3, may include, but not limited to, a chirp signal. The signal sampling rate, start frequency, cutoff frequency and signal amplitude of the predetermined excitation signal can be set, and then use the set predetermined excitation signal to drive the motor. For example, for the predetermined excitation signal, the sampling rate can be set to 48 KHz (this is only a non-limiting example, and the sampling rate can be set depending on specific application scenarios), the start frequency can be set to 50 Hz, the cutoff frequency can be set to 10 kHz, and the signal amplitude can be adjusted according to differences between motors.

Here, the frequency points are frequency points corresponding to excitation sub-signals in the predetermined excitation signal. For the chirp signal, the frequency points of the respective excitation sub-signals gradually become higher or lower, as shown in FIG. 3. As the frequency points of the excitation sub-signals gradually become higher, the signal waveform becomes narrower.

By driving the motor with the predetermined excitation signal, the voltage data, current data, and vibration acceleration data in response to the excitation can be obtained.

The voltage data, current data and vibration acceleration data can be obtained by means of sampling. For example, the signal sampling frequency for each of the voltage data, current data, and vibration acceleration data can be set to 48 kHz for sampling. Alternatively, the signal sampling frequency for the voltage data and the current data can be set to 24 kHz, and the signal sampling frequency for the vibration acceleration data can be set to 21 kHz. The present invention is not limited to any specific settings.

At step 204, the impedance curve is obtained based on the voltage data, the current data, and each frequency point in the predetermined excitation signal.

The impedance can be calculated based on the voltage and the current, and the impedance curve reflecting the correspondence between the impedance and the frequency points can be obtained based on each frequency point in the predetermined excitation signal.

At step 206, a motor frequency response function is obtained based on the vibration acceleration data and each frequency point in the predetermined excitation signal.

The motor frequency response function reflects a vibration acceleration of the motor in response to the excitation at different frequency points. The vibration acceleration may be the maximum vibration acceleration in response to the excitation at the frequency point.

At step 208, the impulse response function of the target motor is obtained based on the motor frequency response function by means of inverse Fourier transform.

At step 210, an NSR parameter and a target vibration signal corresponding to the target motor are obtained.

At step 212, a target motor excitation signal corresponding to the target vibration signal is generated based on the impulse response function, the impedance curve, the NSR parameter, and the target vibration signal.

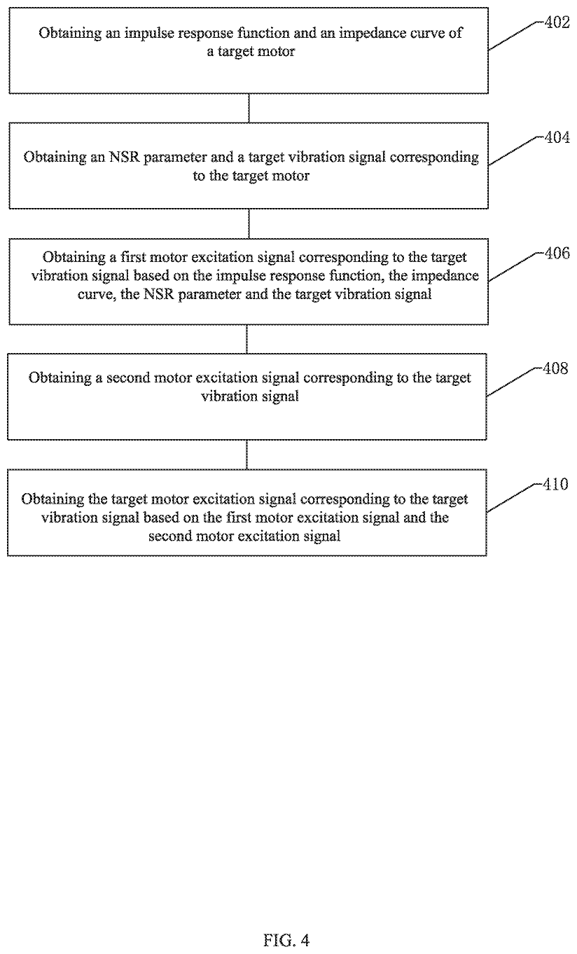

In an embodiment, as shown in FIG. 4, a method for motor excitation signal generation is provided. Specifically, the method includes the following steps.

At step 402, an impulse response function and an impedance curve of a target motor are obtained.

At step 404, an NSR parameter and a target vibration signal corresponding to the target motor are obtained.

At step 406, a first motor excitation signal corresponding to the target vibration signal is obtained based on the impulse response function, the impedance curve, the NSR parameter and the target vibration signal.

Here, the first motor excitation signal can be obtained by reversely derived based on the impulse response function, the impedance curve, the NSR parameter, and the target vibration signal.

At step 408, a second motor excitation signal corresponding to the target vibration signal is obtained.

Here, the second motor excitation signal may be an excitation signal for solving an inertial vibration of the motor, an excitation signal for solving an error in the reverse derivation, or an excitation signal for solving other problems. The present invention is not limited to this.

At step 410, the target motor excitation signal corresponding to the target vibration signal is obtained based on the first motor excitation signal and the second motor excitation signal.

Finally, the first motor excitation signal and the second motor excitation signal are combined/joined to obtain the target motor excitation signal corresponding to the target vibration signal.

In an embodiment, a method for determining the second motor excitation signal is determined based on a resonance frequency. Specifically, the step 408 of obtaining the second motor excitation signal corresponding to the target vibration signal may include the following steps.

At step 408A, a resonance frequency of the target motor is obtained.

Here, the resonance frequency is also referred to as a sympathetic vibration frequency. Specifically, when the frequency of the excitation signal is the resonance frequency, the motor resonates. At this time, the motor has the maximum vibration amplitude.

At step 408B, the second motor excitation signal corresponding to the target vibration signal is obtained based on the resonance frequency.

It is found in a test that when the motor is inertially vibrated, the vibration of the motor depends on the resonance frequency of the motor. Therefore, the resonance frequency of the target motor is obtained, and the vibration signal at the resonance frequency is obtained based on the resonance frequency, and the excitation signal corresponding to the vibration signal is calculated. The excitation signal is then inverted to obtain the second motor excitation signal that hinders the inertial vibration of the motor.

In an embodiment, in order to solve the problem associated with the inertial vibration of the motor when the amplitude of the excitation signal is 0, a brake position of the motor needs to be determined, so as to obtain an excitation signal with a brake effect. Specifically, the step 410 of obtaining the target motor excitation signal corresponding to the target vibration signal based on the first motor excitation signal and the second motor excitation signal may include the following steps.

At step 410A, a brake position determined by exciting the target motor with the first motor excitation signal is obtained.

The motor is driven with the first motor excitation signal obtained by means of reverse derivation. The motor vibrates when driven with the first motor excitation signal to obtain the vibration acceleration data. It is then determined, based on the first motor excitation signal and the obtained vibration acceleration data, at which position the voltage value of the excitation signal is 0 but the vibration acceleration data is not 0, meaning that the excitation has completed at this time but the motor is still in the vibration position due to inertia. This position is determined as the brake position.

At step 410B, the first motor excitation signal and the second motor excitation signal are combined based on the brake position to obtain the target motor excitation signal corresponding to the target vibration signal.

The second motor excitation signal is combined with the first motor excitation signal at the braking position to obtain the target motor excitation signal corresponding to the target vibration signal. The motor excitation signal so obtained overcomes the problem of the inertial vibration of the motor.

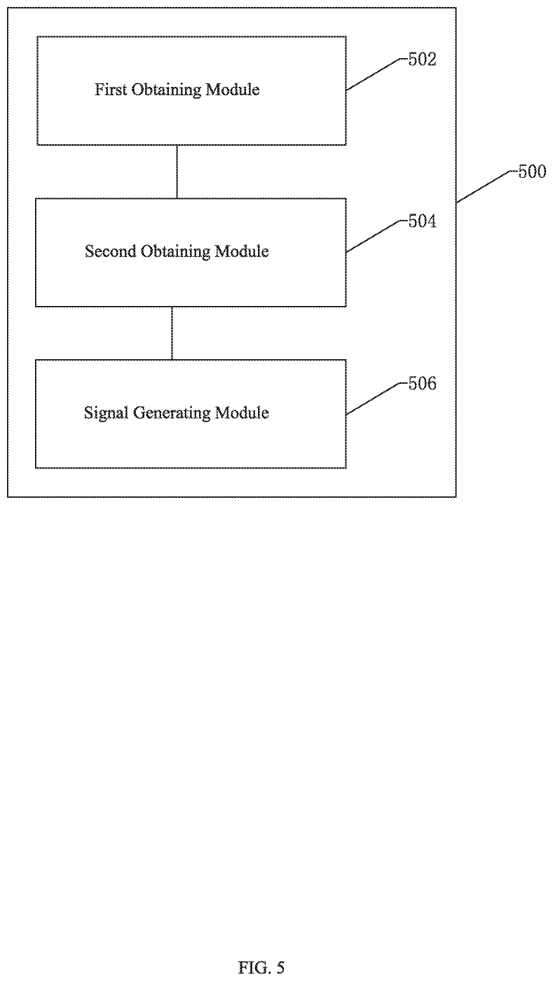

As shown in FIG. 5, an apparatus 500 for motor excitation signal generation is provided. Specifically, the apparatus 500 includes: a first obtaining module 502 configured to obtain an impulse response function and an impedance curve of a target motor; a second obtaining module 504 configured to obtain an NSR parameter and a target vibration signal corresponding to the target motor; and a signal generating module 506 configured to generate a target motor excitation signal corresponding to the target vibration signal based on the impulse response function, the impedance curve, the NSR parameter, and the target vibration signal.

With the above-described apparatus for motor excitation signal generation, first, an impulse response function and an impedance curve of a target motor are obtained. Then, an NSR parameter and a target vibration signal corresponding to the target motor are obtained. Finally, a target motor excitation signal corresponding to the target vibration signal is generated based on the impulse response function, the impedance curve, the NSR parameter, and the target vibration signal. In this way, since the impulse response function and the impedance curve, which reflect the characteristics of the motor, and the target vibration signal to be simulated are obtained, the motor excitation signal is reversely derived based on the impulse response function and the target vibration signal. Compared with the method for existing excitation signal determination, it does not need to repeatedly adjust the excitation signal, which greatly improves the efficiency in determining the excitation signal. Further, it would be difficult to obtain the desired target vibration signal by repeatedly adjusting the excitation signal to obtain the target vibration signal, and the determined excitation signal is inaccurate. According to the present invention, the excitation signal is reversely derived from the target vibration signal directly, and the excitation signal so obtained is more accurate.

In an embodiment, the first obtaining module 502 may include: a driving module configured to drive the target motor with a predetermined excitation signal to obtain voltage data, current data and vibration acceleration data, and the predetermined excitation signal having a plurality of frequency points; an impedance obtaining module configured to obtain the curve based on the voltage data, the current data, and each frequency point in the predetermined excitation signal; a frequency response function determining module configured to obtain a motor frequency response function based on the vibration acceleration data and each frequency point in the predetermined excitation signal; and an impulse response function determining module configured to obtain the impulse response function of the target motor based on the motor frequency response function by means of inverse Fourier transform.

In an embodiment, the signal generating module 506 may include: a first exciting module configured to obtain a first motor excitation signal corresponding to the target vibration signal based on the impulse response function, the impedance curve, the NSR parameter and the target vibration signal; a second exciting module configured to obtain a second motor excitation signal corresponding to the target vibration signal; and a target exciting module configured to obtain the target motor excitation signal corresponding to the target vibration signal based on the first motor excitation signal and the second motor excitation signal.

In an embodiment, the second exciting module may include: a resonance frequency obtaining module configured to obtain a resonance frequency of the target motor; and an excitation signal determining module configured to obtain the second motor excitation signal corresponding to the target vibration signal based on the resonance frequency.

In an embodiment, the target exciting module may include: a brake position obtaining module configured to obtain a brake position determined by exciting the target motor with the first motor excitation signal; and a brake combining module configured to combine the first motor excitation signal and the second motor excitation signal based on the brake position to obtain the target motor excitation signal corresponding to the target vibration signal.

In an embodiment, the apparatus 500 may further include: a storage module configured to storing the motor excitation signal corresponding to the target vibration signal in a tactile sensation library.

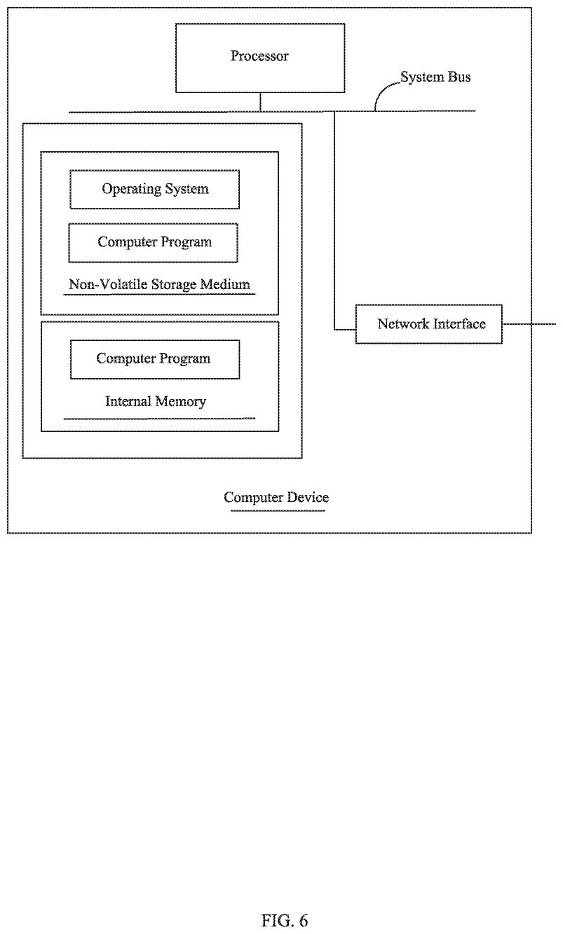

FIG. 6 shows an internal structure diagram of a computer device according to an embodiment. Specifically, the computer device may be a desktop computer or a server. As shown in FIG. 6, the computer device includes a processor, a memory, and a network interface connected via a system bus. Here, the memory includes a non-volatile storage medium and an internal memory. The non-volatile storage medium of the computer device stores an operating system, and may also store a computer program. When executed by the processor, the computer program may cause the processor to implement a method for motor excitation signal generation. The computer program may also be stored in the internal memory. When executed by the processor, the computer program may cause the processor to execute the method for motor excitation signal generation. Those skilled in the art can understand that the structure shown in FIG. 6 is only a block diagram of a part of the structure that is related to the solution of the present invention, and does not constitute a limitation on the computer device to which the solution of the present invention can be applied. The specific computer device may include more or fewer components than those shown in the figure, or some components may be combined, or have a different component arrangement.

In an embodiment, the method for motor excitation signal generation according to the present invention may be implemented in the form of a computer program. The computer program may run on a computer device as shown in FIG. 6. Various program templates constituting the apparatus for motor excitation signal generation can be stored in the memory of the computer device, e.g., the first obtaining module 502, the second obtaining module 504, and the signal generating module 506.

A computer device includes a memory and a processor. The memory stores a computer program which, when executed by the processor, causes the processor to perform steps of: obtaining an impulse response function and an impedance curve of a target motor; obtaining an NSR parameter and a target vibration signal corresponding to the target motor; and generating a target motor excitation signal corresponding to the target vibration signal based on the impulse response function, the impedance curve, the NSR parameter, and the target vibration signal.

With the above-described computer device, first, an impulse response function and an impedance curve of a target motor are obtained. Then, an NSR parameter and a target vibration signal corresponding to the target motor are obtained. Finally, a target motor excitation signal corresponding to the target vibration signal is generated based on the impulse response function, the impedance curve, the NSR parameter, and the target vibration signal. In this way, since the impulse response function and the impedance curve, which reflect the characteristics of the motor, and the target vibration signal to be simulated are obtained, the motor excitation signal is reversely derived based on the impulse response function and the target vibration signal. Compared with the method for existing excitation signal determination, it does not need to repeatedly adjust the excitation signal, which greatly improves the efficiency in determining the excitation signal. Further, it would be difficult to obtain the desired target vibration signal by repeatedly adjusting the excitation signal to obtain the target vibration signal, and the determined excitation signal is inaccurate. According to the present invention, the excitation signal is reversely derived from the target vibration signal directly, and the excitation signal so obtained is more accurate.

In an embodiment, the step of obtaining the impulse response function and the impedance curve of the target motor may include: driving the target motor with a predetermined excitation signal to obtain voltage data, current data and vibration acceleration data, and the predetermined excitation signal having a plurality of frequency points; obtaining the impedance curve based on the voltage data, the current data, and each frequency point in the predetermined excitation signal; obtaining a motor frequency response function based on the vibration acceleration data and each frequency point in the predetermined excitation signal; and obtaining the impulse response function of the target motor based on the motor frequency response function by means of inverse Fourier transform.

In an embodiment, the step of generating the target motor excitation signal corresponding to the target vibration signal based on the impulse response function, the impedance curve, the NSR parameter, and the target vibration signal may include: obtaining a first motor excitation signal corresponding to the target vibration signal based on the impulse response function, the impedance curve, the NSR parameter and the target vibration signal; obtaining a second motor excitation signal corresponding to the target vibration signal; and obtaining the target motor excitation signal corresponding to the target vibration signal based on the first motor excitation signal and the second motor excitation signal.

In an embodiment, the step of obtaining the second motor excitation signal corresponding to the target vibration signal may include: obtaining a resonance frequency of the target motor; and obtaining the second motor excitation signal corresponding to the target vibration signal based on the resonance frequency.

In an embodiment, the step of obtaining the target motor excitation signal corresponding to the target vibration signal based on the first motor excitation signal and the second motor excitation signal may include: obtaining a brake position determined by exciting the target motor with the first motor excitation signal; and combining the first motor excitation signal and the second motor excitation signal based on the brake position to obtain the target motor excitation signal corresponding to the target vibration signal.

In an embodiment, the computer program, when executed by the processor, may cause the processor to, subsequent to generating the target motor excitation signal corresponding to the target vibration signal based on the impulse response function, the impedance curve, the NSR parameter, and the target vibration signal: store the motor excitation signal corresponding to the target vibration signal in a tactile sensation library.

In an embodiment, a computer readable storage medium is provided. The computer readable storage medium stores a computer program which, when executed by a processor, causes the processor to perform steps of: obtaining an impulse response function and an impedance curve of a target motor; obtaining an NSR parameter and a target vibration signal corresponding to the target motor; and generating a target motor excitation signal corresponding to the target vibration signal based on the impulse response function, the impedance curve, the NSR parameter, and the target vibration signal.

With the above-described computer readable storage medium, first, an impulse response function and an impedance curve of a target motor are obtained. Then, an NSR parameter and a target vibration signal corresponding to the target motor are obtained. Finally, a target motor excitation signal corresponding to the target vibration signal is generated based on the impulse response function, the impedance curve, the NSR parameter, and the target vibration signal. In this way, since the impulse response function and the impedance curve, which reflect the characteristics of the motor, and the target vibration signal to be simulated are obtained, the motor excitation signal is reversely derived based on the impulse response function and the target vibration signal. Compared with the method for existing excitation signal determination, it does not need to repeatedly adjust the excitation signal, which greatly improves the efficiency in determining the excitation signal. Further, it would be difficult to obtain the desired target vibration signal by repeatedly adjusting the excitation signal to obtain the target vibration signal, and the determined excitation signal is inaccurate. According to the present invention, the excitation signal is reversely derived from the target vibration signal directly, and the excitation signal so obtained is more accurate.

In an embodiment, the step of obtaining the impulse response function and the impedance curve of the target motor may include: driving the target motor with a predetermined excitation signal to obtain voltage data, current data and vibration acceleration data, and the predetermined excitation signal having a plurality of frequency points; obtaining the impedance curve based on the voltage data, the current data, and each frequency point in the predetermined excitation signal; obtaining a motor frequency response function based on the vibration acceleration data and each frequency point in the predetermined excitation signal; and obtaining the impulse response function of the target motor based on the motor frequency response function by means of inverse Fourier transform.

In an embodiment, the step of generating the target motor excitation signal corresponding to the target vibration signal based on the impulse response function, the impedance curve, the NSR parameter, and the target vibration signal may include: obtaining a first motor excitation signal corresponding to the target vibration signal based on the impulse response function, the impedance curve, the NSR parameter and the target vibration signal; obtaining a second motor excitation signal corresponding to the target vibration signal; and obtaining the target motor excitation signal corresponding to the target vibration signal based on the first motor excitation signal and the second motor excitation signal.

In an embodiment, the step of obtaining the second motor excitation signal corresponding to the target vibration signal may include: obtaining a resonance frequency of the target motor; and obtaining the second motor excitation signal corresponding to the target vibration signal based on the resonance frequency.

In an embodiment, the step of obtaining the target motor excitation signal corresponding to the target vibration signal based on the first motor excitation signal and the second motor excitation signal may include: obtaining a brake position determined by exciting the target motor with the first motor excitation signal; and combining the first motor excitation signal and the second motor excitation signal based on the brake position to obtain the target motor excitation signal corresponding to the target vibration signal.

In an embodiment, the computer program, when executed by the processor, may cause the processor to, subsequent to generating the target motor excitation signal corresponding to the target vibration signal based on the impulse response function, the impedance curve, the NSR parameter, and the target vibration signal: store the motor excitation signal corresponding to the target vibration signal in a tactile sensation library.

It should be noted that the above-described method and apparatus for motor excitation signal generation, computer device and computer readable storage medium belong to a general inventive concept. The content described in connection with the method and apparatus for motor excitation signal generation, the computer device and the computer readable storage medium can be applicable to each other.

It should be noted that the steps in the method embodiments are only used to indicate that the methods need to include the steps, but not used to indicate the order of the steps. For example, for the step 102 and the step 104, the step 104 may be performed before the step 102.

Those of ordinary skill in the art can understand that all or part of the process flows in the method of the above embodiments may be implemented by relevant hardware following instructions of a computer program. The program may be stored in a non-volatile computer readable storage medium. When executed, it program may include the process flows of the embodiments of the above methods. As used herein, any reference to a memory, storage, database or other medium in the embodiments according to the present invention may include a non-volatile memory and/or a volatile memory. The non-volatile memory may include a Read-Only Memory (ROM), a Programmable ROM (PROM), an Electrically Programmable ROM (EPROM), an Electrically Erasable Programmable ROM (EEPROM), or a flash memory. The volatile memory can include a Random Access Memory (RAM) or an external cache memory. For the purpose of non-limiting illustration, a RAM may be available in many forms, such as Static RAM (SRAM), Dynamic RAM (DRAM), Synchronous DRAM (SDRAM), Double Data Rate SDRAM (DDRSDRAIVI), Enhanced SDRAM (ESDRAIVI), Synchronous Chain (Synchlink) DRAM (SLDRAM), memory bus (Rambus) direct RAM (RDRAM), Direct Memory Bus Dynamic RAM (DRDRAM), and memory bus dynamic RAM (RDRAM), etc.

The technical features of the above embodiments can be arbitrarily combined. To simplify the description, not all possible combinations of the technical features in the above embodiments are described. However, as long as there is no conflict in the combination of these technical features, such combination is considered to fall within the scope described in this specification.

The above-described embodiments only illustrates some implementations of the present invention. While the embodiments have been described in detail, the scope of the present invention is not limited to these embodiments. It should be noted that, a number of variants and improvements can be made by a person having ordinary skill in the art, without departing from the concept of the present invention, and all these variants and improvements fall within the protection scope of the present invention, which is defined only by the claims as attached.

What is claimed is:

1. A method for motor excitation signal generation, comprising:
obtaining an impulse response function and an impedance curve of a target motor;
obtaining a Noise to Signal Ratio (NSR) parameter and a target vibration signal corresponding to the target motor; and
generating a target motor excitation signal corresponding to the target vibration signal based on the impulse response function, the impedance curve, the NSR parameter, and the target vibration signal.

2. The method as described in claim 1, wherein said obtaining the impulse response function and the impedance curve of the target motor comprises:
driving the target motor with a predetermined excitation signal to obtain voltage data, current data and vibration acceleration data, and the predetermined excitation signal having a plurality of frequency points;
obtaining the impedance curve based on the voltage data, the current data, and each frequency point in the predetermined excitation signal;
obtaining a motor frequency response function based on the vibration acceleration data and each frequency point in the predetermined excitation signal; and
obtaining the impulse response function of the target motor based on the motor frequency response function by means of inverse Fourier transform.

3. The method as described in claim 1, wherein said generating the target motor excitation signal corresponding to the target vibration signal based on the impulse response function, the impedance curve, the NSR parameter, and the target vibration signal comprises:
obtaining a first motor excitation signal corresponding to the target vibration signal based on the impulse response function, the impedance curve, the NSR parameter and the target vibration signal;
obtaining a second motor excitation signal corresponding to the target vibration signal; and
obtaining the target motor excitation signal corresponding to the target vibration signal based on the first motor excitation signal and the second motor excitation signal.

4. The method as described in claim 3, wherein said obtaining the second motor excitation signal corresponding to the target vibration signal comprises:
obtaining a resonance frequency of the target motor; and
obtaining the second motor excitation signal corresponding to the target vibration signal based on the resonance frequency.

5. The method as described in claim 3, wherein said obtaining the target motor excitation signal corresponding to the target vibration signal based on the first motor excitation signal and the second motor excitation signal comprises:
obtaining a brake position determined by exciting the target motor with the first motor excitation signal; and
combining the first motor excitation signal and the second motor excitation signal based on the brake position to obtain the target motor excitation signal corresponding to the target vibration signal.

6. The method as described in claim 1, further comprising, subsequent to generating the target motor excitation signal corresponding to the target vibration signal based on the impulse response function, the impedance curve, the NSR parameter, and the target vibration signal:
storing the motor excitation signal corresponding to the target vibration signal in a tactile sensation library.

7. An apparatus for motor excitation signal generation, comprising:
a first obtaining module configured to obtain an impulse response function and an impedance curve of a target motor;
a second obtaining module configured to obtain a Noise to Signal Ratio (NSR) parameter and a target vibration signal corresponding to the target motor; and
a signal generating module configured to generate a target motor excitation signal corresponding to the target vibration signal based on the impulse response function, the impedance curve, the NSR parameter, and the target vibration signal.

8. The apparatus as described in claim 7, wherein the first obtaining module comprises:
a driving module configured to drive the target motor with a predetermined excitation signal to obtain voltage data, current data and vibration acceleration data, and the predetermined excitation signal having a plurality of frequency points;
an impedance obtaining module configured to obtain the curve based on the voltage data, the current data, and each frequency point in the predetermined excitation signal;
a frequency response function determining module configured to obtain a motor frequency response function based on the vibration acceleration data and each frequency point in the predetermined excitation signal; and
an impulse response function determining module configured to obtain the impulse response function of the target motor based on the motor frequency response function by means of inverse Fourier transform.

9. A computer device, comprising a memory, a processor, and a computer program stored in the memory and executable by the processor, wherein the processor is operative to, when executing the computer program, perform the steps of the method for motor excitation signal generation as described in claim 1.

10. A computer readable storage medium, storing a computer program which, when executed by a processor, causes the processor to perform the steps of the method for motor excitation signal generation as described in claim 1.
